(19) United States
(12) Patent Application Publication
(10) Pub. No.: US 2004/0081773 A1
(43) Pub. Date: Apr. 29, 2004

(54) Recording sheet and manufacturing process therefor

(75) Inventors: Tadashi Ishida, Chiba (JP); Yoshihiko Tomita, Chib (JP); Kuniaki Kawabe, Chiba (JP); Yukie Ogawa, Chiba (JP); Futoshi Hoshino, Chiba (JP)

Correspondence Address: BURNS DOANE SWECKER & MATHIS L L P, POST OFFICE BOX 1404, ALEXANDRIA, VA, 22313-1404, US

(73) Assignee: Mitsui Chemicals, Inc., Tokyo (JP)

(21) Appl. No.: 10/690,567

(22) Filed: Oct. 23, 2003

Related U.S. Application Data
(62) Division of application No. 10/018,813, filed on Dec. 21, 2001, now abandoned.
Application No. 10/018,813 is a 371 of international application No. PCT/JP01/03696, filed on Apr. 27, 2001.

(30) Foreign Application Priority Data
Apr. 28, 2000 (JP) 2000-129379

(51) Int. Cl. B32B 3/00

(52) U.S. Cl. 428/32.1

(57) ABSTRACT

For providing an inkjet recording sheet with excellent gloss, ink absorbency, color density, water resistance, light resistance and anti-yellowing property, as well as a process for manufacturing the recording sheet, this invention provides an inkjet recording sheet comprising at least one layer containing a cationic particulate organic component on a sheet support, wherein the layer containing the cationic particulate organic component comprises a void-forming component consisting of a cationic particulate organic component which is made of a particular (co)polymer and which is endowed with a cationic function.

### BACKGROUND OF THE INVENTION

1. Field of the Invention

This invention can be applied to a printer or plotter utilizing an inkjet recording system. In particular, this invention relates to a recording sheet for inkjet recording which has gloss comparable to that of a commercially available cast paper and a process for manufacturing the recording sheet.

2. Description of the Prior Art

In an inkjet recording system, small ink drops are discharged onto a recording sheet such as a paper by a variety of operation principles for recording an image or character. The recording system has characteristics such as a higher speed, lower noise, easy multicolored printing, great flexibility in a recording pattern and elimination of the needs for development and fixing, and thus has quickly become widespread in a variety of applications as a recording device for, e.g., various figures including Chinese characters and color images. By increasing resolution and expanding a color reproduction range, an image produced by a multicolor inkjet system can be comparable to that produced by multicolor printing according to photoengraving or that printed by a color photography system, and furthermore, is less expensive than a photographic technique in an application with a smaller printing number so that it has been widely used even in a field of full-color image recording.

For a printer or plotter utilizing an inkjet system, improvement in resolution and expansion of a color reproduction range have been attempted for meeting requirements for further improvement in image quality from the market, and these have been dealt with by increasing an amount of discharged ink. Therefore, increase in an ink receiving capacity suitable to a discharge amount has become an important technical target for a recording sheet, and it is, thus, essential to ensure an increased ink receiving capacity and form a coated layer exhibiting good color development. Furthermore, an appearance such as gloss, rigidity and hue have been needed to be compatible to those in a silver photograph or printing paper, but a conventional ink-jet recording paper such as a fine paper and a coated paper have not meet these needs.

In particular, lustering according to the prior art causes loss of ink absorbency which is important for an inkjet recording sheet. For ensuring the absorbency, it is necessary to form a coated layer having a large void content. Thus, a large amount of inorganic particles have been used in a coating composition for forming the coated layer having a large void content. However, due to the particles, the surface of the coated layer becomes coarse, and consequently, only recording sheet with low gloss, so-called matted sheet, is obtained.

A general treatment for endowing gloss is smoothing the surface of the coated layer by passing a paper between heated rolls under a pressure using a calender apparatus such as a super calender and a gloss calender. However, calendering under a high linear load improves gloss, but reduces void content in a coated layer, leading to decrease in ink absorption speed and ink overflow due to reduced absorption capacity. The calendering conditions must be selected within a limitation to an acceptable ink absorption capacity, and thus both ink absorption and gloss cannot be satisfactorily achieved according to the prior art to date.

For the purpose of meeting requirements for these conflicting properties, ink absorbency and gloss, it has been proposed to prepare an inkjet recording sheet by a process called cast-coating while a large amount of fine inorganic particles are contained in a coated layer. Even the process cannot simultaneously meet the requirements for these conflicting properties, ink absorbency and gloss, in a recent inkjet printer or plotter with an increased ink discharge. When employing a design focusing on ink absorbency, for example, when improving ink absorbency by increasing voids using a large amount of inorganic particles, high gloss cannot be achieved and surface strength may be reduced. In a design focusing on gloss, for example, when reducing the amount of inorganic particles, higher gloss can be achieved while voids are reduced so that ink absorbency may not be ensured.

In general, an ink for inkjet recording comprises an anionic water-soluble dye dissolved in a solvent mainly comprising water. Therefore, when employing a design focusing on-ink absorbency, for example, when improving ink absorbency by increasing voids with a large amount of inorganic particles, a color density may be reduced due to deep permeation of the dye into a recording sheet. For improving a color density, it is necessary to fix the dye in the ink on the surface of the recording sheet as much as possible. Furthermore, the dye must be fixed on the surface of the recording sheet for improving water resisting property, i.e., for preventing the dye from being detached when the recording sheet is in contact with water. For solving the problem, there has been a proposal that an anionic dye is fixed by adding a cationic polymer to a coated layer, but increasing the cationic polymer may lead to unsatisfactory ink absorbency due to reduction in an amount of inorganic particles.

Recent progress in inkjet recording system has allowed us to obtain a sharp image and excellent printing quality and thus to obtain image quality comparable to that in a photograph, but compared with a photograph, a printed sheet by inkjet technique has poorer light-resistance, i.e., fading of a printed image after a long term storage, and anti-yellowing property, i.e., yellowing of a recording sheet surface after a long term storage. However, a recent high-gloss recording sheet comprises a large amount of fine inorganic particles in its coated layer as described above, for achieving both higher gloss and ink absorbency, and much finer inorganic particles have been chosen for further improving performance As inorganic particles, silica and alumina are generally preferable. However, as they become finer, their surface area is drastically increased and higher surface activity of the inorganic particles may considerably deteriorate light resistance or anti-yellowing.

As described above, to date it is difficult to provide an ink-jet recording sheet meeting all the requirements of improved gloss, ink absorbency, color density, water resistance, light resistance and anti-yellowing. Examples of the prior art will be described.

JP-A 11-11011 has disclosed an inkjet recording sheet prepared by cast-coating a coating composition consisting of cationic colloidal particles, main component of which is alumina particle, and a cationic latex at a temperature higher than the glass transition temperature of the latex. The cationic latex used is preferably 2 to 70 parts by weight, most preferably 3 to 30 parts by weight to 100 parts by weight of the cationic colloidal particles. There is not a clear definition for the cationic latex, but it includes a latex cationized with a cationic group and a latex whose surface is cationized with a cationic surfactant. In the examples, a cationic latex prepared with a cationic surfactant is evaluated.

JP-A 11-123867 has disclosed an inkjet recording sheet comprising a cationic acrylic resin emulsion in its white-pigment layer. Examples of a white pigment include inorganic particles such as clay, calcium carbonate and titanium dioxide and organic particles such as polyethylene, polystyrene and polyacrylate. The cationic acrylic resin emulsion in the white-pigment layer is 100 to 5 parts by weight, most preferably 50 to 30 parts by weight to 100 part by weight of the white pigment. A cationic monomer used for preparing the cationic acrylic resin emulsion is preferably 1 to 5 wt % to the total amount of the monomers.

JP-A 11-58943 has disclosed an inkjet recording material prepared by applying a liquid comprising a non-spherical silica and a water-dispersible cationic polymer on a support and drying it. Preferably, the content of the water-dispersible cationic polymer in an ink receiving layer is 1 to 30 wt % while the content of inorganic particles is 75 to 95 wt %.

JP-A 11-20306 has disclosed an inkjet recording paper comprising a support on which is provided an ink absorbing layer containing a cationic mordant capable of mordanting an anionic dye. Preferably, the ink absorbing layer comprises inorganic particles such as silica and alumina, the weight ratio of the cationic mordant is 0.01 to 3 to the inorganic particles and the cationic mordant is a water-soluble mordant with an average molecular weight of 50000 or less.

JP-B 7-53469 has disclosed an inkjet recording sheet comprising a support and a coating layer consisting of a pigment and a binder resin on the support, wherein the binder is a cationic copolymer consisting of (a) a component comprising an aliphatic acid vinyl ester and (b) 0.05 to 0.4 mol % of a cationic monomer comprising an ethylenic unsaturated group and a tertiary amino or quaternary ammonium group. A pigment used is a fine-grained silica and so forth. The content of the cationic copolymer in the coating layer is preferably 5 to 50 wt %.

JP-A 9-59898 has disclosed a resin-coated printing paper wherein on a paper matrix is provided a coated layer comprising an emulsion of a copolymer with a weight average molecular weight of 1000 to 50000 consisting of 80 to 98.5 mol % of an ethylene unit, 0.5 to 10 mol % of an acrylate unit and 1 to 10 mol % of a cationic acrylamide unit. The resin-coated printing paper is quite suitable to offset printing.

In these references, inorganic particles are used for providing voids and various polymers are used as a binder resin for binding inorganic particles together. Such approaches, therefore, have drawbacks due to the use of inorganic particles.

For solving these problems, an object of this invention is to provide an inkjet recording sheet with excellent gloss, ink absorbency, color density, water resistance, light resistance and anti-yellowing property, as well as a process for manufacturing the recording sheet.

### SUMMARY OF THE INVENTION

We have intensely attempted to accomplish the object and have finally found that an inkjet recording sheet in which at least one layer on a sheet support comprises particular cationic organic particles and which has certain levels of liquid absorption and gloss exhibits improved gloss and ink absorbency as well as excellent color density, light resistance and anti-yellowing property, resultantly achieved this invention.

This invention provides:

[1] An inkjet recording sheet comprising at least one layer containing a cationic particulate organic component on a sheetsupport, wherein the layer containing the cationic particulate organic component comprises a void-forming component consisting substantially of a cationic particulate organic component selected from the group consisting of (meth)acrylate (co)polymers, methyl methacrylate-butadiene copolymers, styrene-butadiene copolymers, ethylene-vinyl acetate copolymers and olefinic polymers, and copolymers of two or more of these, which are endowed with a cationic function.

[2] The inkjet recording sheet as defined in [1], wherein the cationic particulate organic component is a thermoplastic particulate resin.

[3] The inkjet recording sheet as defined in [1] or [2], wherein the cationic particulate organic component is a cationic particulate emulsion prepared by copolymerizing (A) an alkyl (meth)acrylate, (B) an amino group containing (meth)acrylate monomer and (C) other copolymerizable monomer.

[4] The inkjet recording sheet as defined in [3], wherein the amounts of (A) the alkyl (meth)acrylate monomer, (B) the amino group containing (meth)acrylate monomer and (C) the other copolymerizable monomer are 30 wt % to 99.8 wt %, 0.2 wt % to 40 wt % and 0 wt % to 30 wt %, respectively, based on the total weight of (A), (B) and (C).

[5] The inkjet recording sheet as defined in any of [1] to [3], wherein the glass transition temperature of the cationic particulate organic component is 65° C. to 200° C. both inclusive.

[6] The inkjet recording sheet as defined in any of [1] to [5], wherein the weight average molecular weight of the cationic particulate organic component is 60000 or more.

[7] The inkjet recording sheet as defined in any of [1] to [6], wherein the recording sheet has a liquid absorption of 2.00 to 4.00 μL 0.1 sec after dropping 4 μL of pure water on its recording surface and has gloss of 50 or more at 75.0

[8] The inkjet recording sheet as defined in any of [1] to [7], wherein the recording sheet has a liquid absorption per contact area of a droplet of 0.5 to 2.00 μL/cm² 0.1 sec after dropping 4 μL of pure water on the recording surface of the recording sheet.

[9] The inkjet recording sheet as defined in any of [1] to [8], wherein the layer containing the cationic particulate organic component is the outermost layer of the recording surface.

[10] The inkjet recording sheet as defined in any of [1] to [9], wherein the sheet support is a paper or plastic sheet.

[11] The inkjet recording sheet as defined in any of [1] to [10], wherein the layer containing the cationic particulate organic component contains no inorganic particles.

[12] A process for manufacturing the inkjet recording sheet as defined in any of [1] to [11] wherein a layer containing a cationic particulate component is applied by cast coating, comprising the steps of applying a coating composition containing the cationic particulate organic component on a sheet support and pressing a mirror roll onto the coated surface.

[13] The process for manufacturing the inkjet recording sheet as defined in [12], wherein the surface temperature of the mirror roll is lower than a glass transition temperature of the cationic particulate organic component.

### DETAILED DESCRIPTION OF PREFERRED EMBODIMENTS

An inkjet recording sheet of this invention is a recording sheet comprising at least one layer containing a cationic particulate organic component on a sheet support and having particular levels of liquid absorption and gloss, which will be described in detail.

Determination of a Liquid Absorption

A liquid absorption of a recording surface of this invention is as determined 0.1 sec after vertically dropping a pure-water droplet of 4 μL on a recording surface of a sample held horizontally under the conditions of 20° C. and 65% RH. In a recording sheet, a large amount of ink must be very quickly absorbed after being dropped because gradual ink absorption after dropping causes blurring, leading to poor image quality.

The above liquid absorption is specifically determined as follows, using, for example DAT (Dynamic Absorption Tester) 1100 DAT MKII (FIBRO Company). On a sample surface is dropped 4 μL of pure water, and the state after dropping is videotaped. Then, from the video image taken are determined a contact angle and a diameter of the droplet 0.1 sec after dropping, from which the remaining liquid amount on the sample surface is estimated. A difference between the remaining amount and the initial droplet amount is calculated as a liquid absorption. The calculated liquid absorption is given in a unit of volume (μL). The calculated value is divided by a contact area estimated from the diameter of the dropped droplet to calculate a liquid absorption per unit area (μL/cm²). A specific calculation equation is as follows.

Liquid absorption per unit area (μL/cm²)=Liquid absorption (μL)/[(Diameter of a droplet (cm)/2)²×π]

In this equation, the liquid absorption is expressed in two different units because of the following reason. For example, a high liquid absorption expressed in a unit of volume (μL) means good ink absorbency, resulting in rapid drying, while a low liquid absorption per unit area (μL/cm²) means large spreading of a droplet on a recording sheet surface, often leading to burring and thus deteriorated image quality. A higher liquid absorption per unit area (μL/cm²) is, therefore, more preferable.

In a recording sheet of this invention, a liquid absorption is preferably 2.00 to 4.00 μL, more preferably 3.00 to 4.00 μL as determined 0.1 sec after dropping 4 μL of pure water on a recording surface. When the liquid absorption is 2.00 μL or more, ink absorbency and drying property are good. Furthermore, since the amount of dropped pure water is 4 μL, the liquid absorption never exceed 4.00 μL.

A liquid absorption per unit area in a recording sheet of this invention is preferably 0.50 to 2.00 μL/cm², more preferably 0.50 to 1.50 μL/cm².

A liquid absorption of 0.50 μL/cm² or more gives so good ink absorbency that image deterioration due to ink overflow, while a liquid absorption of 2.00 μL/cm² or less advantageously gives good water resistance and color density.

Determination of Gloss

In this invention, gloss is determined as a glossiness on a recording sheet surface at 75° according to JIS Z8741. For example, it can be determined using a bending glossimeter type GM-3D (Murakami Color Technology Institute).

A recording sheet of this invention has a glossiness of 50 or more, preferably 60 or more, more preferably 65 or more, most preferably 70 or more, at 75°. If it is less than 50, gloss is insufficient to give a recording sheet with gloss.

Cationic Particulate Organic Component

A preferable cationic particulate organic component in this invention is a water-insoluble thermoplastic particulate polymer comprising a cationic functional group such as amino group. Examples of a polymer which can be used include acrylic polymers (polymers or copolymers of an acrylate and/or methacrylate), MBR polymers (methyl methacrylate-butadiene copolymers), SBR polymers (styrene-butadiene copolymers), EVA polymers (ethylene-vinyl acetate copolymers) and olefinic polymers. An acrylic polymer is more preferable because of its excellent anti-yellowing property in a recording sheet for a long period.

A more preferable cationic particulate organic component is a cationic particulate organic component prepared by copolymerizing (A) an alkyl (meth)acrylate monomer, (B) an amino group containing acrylate monomer and/or an amino group containing methacrylate monomer, and (C) other copolymerizable monomer.

Individual thermoplastic polymers will be more specifically described.

(A) Examples of an alkyl(meth)acrylate monomer include acrylates such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate and benzyl acrylate;

methacrylates such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate; and

other alkyl (meth)acrylates having 1 to 12 carbon atoms, alone or in combination of two or more.

Among these, compounds without a benzene ring are preferable as (A); more preferably, methyl acrylate, n-butyl acrylate, isobutyl acrylate, ethyl acrylate, 2-ethylhexyl acrylate, methyl methacrylate, n-butyl methacrylate, isobutyl methacrylate, ethyl methacrylate and 2-ethylhexyl methacrylate because a compound with a benzene ring may deteriorate anti-yellowing property.

(B) Examples of an amino group containing (meth)acrylate monomer include aminoalkyl acrylates and aminoalkyl methacrylates such as N,N-dimethylaminoethyl acrylate, N,N-dimethylaminoethyl methacrylate, N,N-dimethylaminopropyl acrylate, N,N-dimethylaminopropyl methacrylate, N,N-t-butylaminoethyl acrylate, N,N-t-butylaminoethyl methacrylate, N,N-monomethylaminoethyl acrylate and N,N-monomethylaminoethyl methacrylate;

N-aminoalkylacrylamides and N-aminoalkylmethacrylamides such as N,N-dimethylacrylamide, N,N-diethylacrylamide, N,N-diethylmethacrylamide, N,N-dimethylaminopropylacrylamide, N,N-dimethylaminopropylmethacrylamide, N,N-dimethylaminoethylacrylamide, N,N-dimethylaminoethylmethacrylamide and N-isopropylacrylamide;

quaternary salts of the above aminoalkyl (meth)acrylates, N-aminoalkylacrylamides and N-aminoalkylacrylamides quaternarized with halomethyl, haloethyl, halobenzyl or the like where halo represents chloride, bromide, iodide or the like;

acryloylmorphorine; 2-(2′-hydroxy-5′-methacryloyloxyethylphenyl)-2H-benzotriazole; 2-(2 ′-hydroxy-5′-methacryloyloxyethylphenyl)-benzotriazole; 2-hydroxy-4-(2-methacryloyloxy)ethoxybenzophenone; 2-(2′-hydroxy-5′-methacryloyloxyphenyl)-5-chlorobenzotriazole; 1,2,2,6,6-p entamethyl-4-piperidyl methacrylate and 2,2,6,6-tetramethyl-4-piperidyl methacrylate, which can be used alone or in combination of two or more.

Among these are preferred quaternary salts of the above aminoalkyl (meth)acrylates, N-aminoalkylacrylamides and N-aminoalkylacrylamides quaternarized with halomethyl, haloethyl, halobenzyl or the like where halo represents chloride, bromide, iodide or the like.

Compounds comprising other group other than an amino group which can endow a polymer with cationic property can be used in this invention.

These monomers can be used as a copolymer component for endowing cationic property not only to a (meth)acrylate (co)polymer but also to a methyl methacrylate-butadiene copolymer, styrene-butadiene copolymer, ethylene-vinyl acetate copolymer or an olefinic polymer.

When using an amidino compound as a radical initiator, a polymer can be made cationic without a particular copolymer component and a (co)polymer thus obtained can be used as a cationic particulate organic component in this invention.

(C) Examples of other copolymerizable monomer include radical-polymerizable monomers other than (A) or (B); for example, unsaturated carboxylic acids such as acrylic acid, methacrylic acid, itaconic acid, maleic acid, fumaric acid, acrylic anhydride, methacrylic anhydride, maleic anhydride, itaconic anhydride and fumaric anhydride;

hydroxy-containing vinyl compounds such as 2-hydroxyethyl acrylate, hydroxypropyl acrylate, 4-hydroxybutyl acrylate, 2-hydroxyethyl methacrylate, hydroxypropyl methacrylate and 4-hydroxybutyl methacrylate; aromatic vinyl compounds such as styrene, 2-methylstyrene, t-butylstyrene, chlorostyrene, vinylanisole, vinylnaphthalene and divinylbenzene; amides such as acrylamide, methacrylamide, N-methylolmethacrylamide, N-methylolacrylamide, diacetone acrylamide and maleamide; vinyl esters such as vinyl acetate and vinyl propionate; halogenated vinylidenes such as vinylidene chloride and vinylidene fluoride; vinyl chloride; vinyl ether; vinyl ketone; vinylamide; chloroprene; ethylene; propylene; isoprene; butadiene; vinylpyrrolidone; 2-methoxyethyl acrylate; 2-ethoxyethyl acrylate; glycidyl acrylate; glycidyl methacrylate; allyl glycidyl ether; acrylonitrile; methacrylonitrile; ethyleneglycol dimethacrylate; diethyleneglycol dimethacrylate; triethyleneglycol dimethacrylate; polyethyleneglycol dimethacrylate; polypropyleneglycol dimethacrylate; 1,3-butyleneglycol dimethacrylate; 1,6-hexanediol dimethacrylate; neopentylglycol dimethacrylate; polyethyleneglycol diacrylate; 1,6-hexanediol diacrylate; neopentylglycol diacrylate; tripropyleneglycol diacrylate; polypropyleneglycol diacrylate; trimethylolpropane trimethacrylate; tetramethylolmethane tetracrylate; allyl methacrylate; dicyclopentenyl acrylate; dicyclopentenyloxyethyl acrylate; isopropenyl-α,α-dimethylbenzyl isocyanate and allyl mercaptan, which can be used alone or in combination of two or more.

As (C) are preferred monomers comprising a functional group which can strongly interact with a dye, e.g., a functional group which can form hydrogen bonding with a dye; for example, unsaturated carboxylic acids, hydroxy-containing vinyl compounds, aromatic vinyl compounds and amides because of their light resistance. Unsaturated carboxylic acids and hydroxy-containing vinyl compounds exhibiting good anti-yellowing property are more preferable.

Contents for (A) an alkyl acrylate monomer and/or an alkyl methacrylate monomer, (B) an amino group containing acrylate monomer and/or an amino group containing methacrylate monomer, and (C) other copolymerizable monomer are preferably 30 wt % to 99.8 wt %, 0.2 wt % to 40 wt %, and 0 wt % to 30 wt %, respectively; more preferably 50 wt % to 99.8 wt %, 0.2 wt % to 20 wt %, and 0 wt % to 30 wt %, respectively, on the basis of the total weight.

When (A) is contained at 30 wt % or more, a cationic particulate organic component can have suitable hydrophilicity as well as good water resistance and ink absorbency. When (A) is contained at 99.8 wt % or less, an ink dye is fixed, leading to a higher color density.

(B) at 0.2 wt % or more can facilitate fixation of an ink dye, leading to suitable color density and water resistance, while (B) at 40 wt % or less can make a cationic particulate organic component suitably hydrophilic, contribute to maintaining water resistance and provide good ink absorbency because of appropriately fine voids.

Molecular Weight of a Cationic Particulate Organic Component

A weight average molecular weight of a cationic particulate organic component in this invention is preferably 60000 or more, more preferably 100000 or more. A weight average molecular weight of 60000 or more can prevent a cationic particulate organic component from being deformed and thus voids from being reduced, resulting in higher ink absorbency. There is not a specific upper limit to the molecular weight, but it does not have to be about 1000000 or more.

Particle Size of a Cationic Particulate Organic Component

An average particle size of a cationic particulate organic component in this invention is preferably 0.01 μm to 1 μm, more preferably 0.05 μm to 0.5 μm. When the average particle size is 0.01 μm or more, appropriate voids are formed among particles to provide good ink absorbency, while when it is 1 μm or less, flatness of a surface is advantageously good, resulting in a higher glossiness.

Glass Transition Temperature (Tz) of a Cationic Particulate Organic Component

A glass transition temperature of a cationic particulate organic component is preferably 65° C. or higher, more preferably 75° C. or higher. The upper limit to the glass transition temperature is generally 200° C., preferably 150° C. If the glass transition temperature is lower than 65° C., fine voids in a surface layer tend to be reduced, leading to deterioration in ink absorbency. If a drying temperature is high during drying, the fine voids in the coated layer may be reduced. The drying temperature must be, therefore, lowered, and it may lead to a reduced production efficiency.

A glass transition temperature herein can be determined from a DSC curve according to JIS K 7121.

Preparation of a Cationic Particulate Organic Component

A cationic particulate organic component used in this invention can be prepared by well-known emulsion polymerization or mechanical emulsification. For example, as emulsion polymerization, different monomers charged together can be polymerized in the presence of a dispersing agent and an initiator. Alternatively, while continuously feeding monomers, they are polymerized at a polymerization temperature of generally 30 to 90° C. to provide an aqueous dispersion of the organic particles.

A preferable dispersing agent is a cationic surfactant and/or a nonionic surfactant, which will be more specifically described.

Examples of a cationic surfactant include lauryl-trimethylammonium chloride, stearyltrimethyl-ammonium chloride, cetyl-trimethylammonium chloride, distearyl-dimethylammonium chloride, an alkylbenzyl-dimethylammonium chloride, lauryl betaine, stearyl betaine, lauryl-dimethylamine oxide, lauryl-carboxymethyl-hydroxyethylimidazolinium betaine, coconutamine acetate, stearylamine acetate, an alkylamine-guanidie-polyoxyethanol and an alkylpicolinium chloride, which can be used alone or in combination of two or more.

Examples of a nonionic surfactant include polyoxyethylene lauryl ether, polyoxyethylene octylphenyl ether, polyoxyethylene oleylphenyl ether, polyoxyethylene nonylphenyl ether, an oxyethylene-oxypropylene block copolymer, tert-octylphenoxyethyl-polyethoxyethanol and nonylphenoxyethyl-polyethoxyethanol, which can be used alone or in combination of two or more.

A dispersing agent can be a cationic water-soluble polymer and/or a nonionic water-soluble polymer. Examples of a cationic water-soluble polymer include cationized polyvinyl alcohol, cationized starch, cationized polyacrylamide, cationized polymethacrylamide, polyamide-polyurea, polyethylenimine, a copolymer of allylamine or its salt, an epichlorhydrine-dialkylamine addition polymer, a polymer of a diallylalkylamine or its salt, a polymer of a diallyldialkylammonium salt, a copolymer of a diallylamine or its salt with sulfur dioxide, a copolymer of a diallylalkylammonium salt with sulfur dioxide, a copolymer of a diallyldialkylammonium salt with a diallylamine or its salt, a polymer of a dialkylaminoethyl (meth)acrylate quaternary salt, a diallyldialkylammonium salt-acrylamide copolymer and an amine-carboxylic acid copolymer, which can be used alone or in combination of two or more.

Examples of a nonionic water-soluble polymer include polyvinyl alcohol and its derivatives; starch derivatives such as oxidized starch, etherilized starch and phosphorylated starch; polyvinylpyrrolidone derivatives such as polyvinylpyrrolidone and a vinyl acetate-polyvinylpyrrolidone copolymer; cellulose derivatives such as carboxymethyl cellulose and hydroxymethyl cellulose; polyacrylamide and its derivatives; polymethacrylamide and its derivatives; gelatin; and casein, which can be used alone or in combination of two or more.

There are no specific restrictions to the amount of a dispersing agent, but it is generally 0.02 to 20 wt % on the basis of the total weight of monomers involved in (co)polymerization.

An initiator which can be used in polymerization is a common radical initiator; for example, hydrogen peroxide; persulfates such as ammonium persulfate and potassium persulfate; organic peracid derivatives such as cumene hydroperoxide, t-butyl hydroperoxide, benzoyl peroxide, t-butyl peroxy-2-ethylhexanoate, t-butyl peroxybenzoate and lauroyl peroxide; azo compounds such as azobisisobutyronitrile, 2,2′-azobis(2-amidinopropane)-dihydrochloride, 2,2′-azobis[2-(N-phenylamidino)propane]-dihydrochloride, 2,2′-azobis{2-[N-(4-chlorophenyl) amidino]propane}-dihydrochloride, 2,2′-azobis{2-[N-(4-hydroxyphenyl)amidino]prop ane}-dihydrochloride, 2,2′-azobis[2-(N-benzylamidino)propane]-dihydrochloride, 2,2′-azobis[2-(N-allylamidino)propane]-dihydrochloride, 2,2′-azobis{2-[N-(2-hydroxyethyl) amidino]propane}-dihydrochloride, 2,2′-azobis{2-methyl-N-[1,1-bis(hydroxymethyl)-2-hydroxyethyllpropionamide}, 2,2′-azobis{2-methyl-N-[1,1-bis(hydroxymethyl)ethyl]propionamide}, 2,2′-azobis[2-methyl-N-(2-hydroxyethyl)propionamide] and 2,2′-azobis(isobutylamide)-dihydride; and redox initiators which are a combination of any of the above compounds with a metal ion such as iron ion and a reducing agent such as sodium sulfoxylate, formaldehyde, sodium pyrosulfite, sodium hydrogen sulfite, L-ascorbic acid and Rongalite, which can be used alone or in combination of two or more.

In this invention, a (co)polymercan be made cationic without, e.g., an amino group containing monomer, particularly when using an amidino group containing initiator such as 2,2′-azobis(2-amidinopropane) dihydrochloride, 2,2′-azobis[2-(N-phenylamidino)propane] dihydrochloride, 2,2′-azobis{2-[N-(4-chlorophenyl)amidino]propane} dihydrochloride, 2,2′-azobis{2-[N-(4-hydroxyphenyl)amidino]propane} dihydrochloride, 2,2′-azobis[2-(N-benzylamidino)propane] dihydrochloride, 2,2′-azobis[2-(N-allylamidino)propane]-dihydrochloride and 2,2′-azobis{2-[N-(2-hydroxyethyl)amidino]propane} dihydrochloride.

The amount of an initiator is generally 0.1 to 5 wt % on the basis of the total weight of monomers involved in (co)polymerization.

If necessary, a molecular-weight adjusting agent can be used, including mercaptans such as t-dodecyl mercaptan and n-dodecyl mercaptan; and allyl compounds such as allylsulfonic acid, metallylsulfonic acid and their sodium salts.

Content of a Cationic Particulate Organic Component

The content of a cationic particulate organic component in a layer comprising the cationic particulate organic component in this invention is preferably 31 to 100 wt %, more preferably 51 to 100 wt %, further preferably 71 to 100 wt %. The content of 31 wt % or more provides adequate fixation of an ink dye, resulting in good color density and water resistance.

Other Additives

A layer comprising a cationic particulate organic component in this invention may comprise a polymer which can act as a binder, for improving surface strength and gloss. A polymer which can act as a binder is, for example, a water-soluble polymer or an aqueous dispersion of a water-insoluble polymer, which will be more specifically described.

Examples of water-soluble polymer are cationic water-soluble polymer, including cationized polyvinyl alcohol, cationized starch, cationized polyacrylamide, cationized polymethacrylamide, polyamide-polyurea, polyethylenimine, a copolymer of allylamine or its salt, an epichlorhydrine-dialkylamine addition polymer, a polymer of a diallylalkylamine or its salt, a polymer of a diallyldialkylammonium salt, a copolymer of a diallylamine or its salt with sulfur dioxide, a copolymer of a diallylalkylammonium salt with sulfur dioxide, a copolymer of a diallyldialkylammonium salt with a diallylamine or its salt, a polymer of a dialkylaminoethyl (meth)acrylate quaternary salt, a diallyldialkylammonium salt-acrylamide copolymer and an amine-carboxylic acid copolymer.

Examples of water-soluble polymer are nonionic water-soluble polymer, including polyvinyl alcohol and its derivatives; starch derivatives such as oxidized starch, etherilized starch and phosphorylated starch; polyvinylpyrrolidone derivatives such as polyvinylpyrrolidone and a vinyl acetate-polyvinylpyrrolidone copolymer; cellulose derivatives such as carboxymethyl cellulose and hydroxymethyl cellulose; polyacrylamide and its derivatives; polymethacrylamide and its derivatives; gelatin; and casein.

Examples of aqueous dispersion of water-insoluble polymer include those of cationic and/or nonionic acrylic polymers such as a polymer or copolymer of an acrylate and/or a methacrylate; MBR polymers such as a methyl methacrylate-butadiene copolymer; SBR polymers such as a styrene-butadiene copolymer; urethane polymers; epoxy polymers; EVA polymers such as an ethylene-vinyl acetate copolymer.

An aqueous dispersion of polyvinyl alcohol, cationized polyvinyl alcohol or an acrylic polymer such as a polymer or copolymer of an acrylate and/or a methacrylate is preferable because of its excellent anti-yellowing property. For an aqueous dispersion, a glass transition temperature of the polymer is preferably 60° C. or lower and the lower limit of Tg is −10° C. The polymer mentioned above is added for acting as a binder, but not for forming voids like a cationic particulate organic component so that may have different properties from those of the latter.

The content of the polymer used as a binder is preferably 0 to 20 parts by weight to the amount of the cationic particulate organic component. If it is more than 20 parts by weight, voids tend to be reduced, leading to deteriorated ink-absorbency.

A layer comprising a cationic particulate organic component in this invention can contain a particulate inorganic component, whose specific examples include light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, pseudoboehmite, aluminum hydroxide, lithopone, zeolite and magnesium hydroxide. It is preferably silica or alumina, more preferably a particulate component with a primary diameter of 100 nm or less for improving ink absorbency by providing a higher void content, while its lower limit is about 5 nm.

When the particulate inorganic component is contained in a layer comprising a cationic particulate organic component in this invention, its content is 1 to 40 parts by weight, preferably 1 to 20 parts by weight to 100 parts by weight of the cationic particulate organic component. If the inorganic component is more than 40 parts by weight to 100 parts by weight of the organic component, anti-fading and anti-yellowing properties may be deteriorated.

The cationic particulate organic component in this invention can impart excellent ink absorbency and gloss without the presence of the inorganic particles. It is, therefore, preferable not to add a particulate inorganic component to prevent deterioration in anti-fading or anti-yellowing property due to addition of inorganic particles.

Additionally, a layer comprising a cationic particulate organic component in this invention may comprise additives such as antistatic agents, antioxidants, dry paper strong agents, wet paper strong agents, waterproofing agents, preservatives, UV absorbers, photostabilizers, fluorescent whitening agents, color pigments, color dyes, wetting agents, foaming agents, mold releasing agents, foam inhibitors, defoamers, fluidity modifiers, thickeners, pigment dispersing agents and cationic fixers.

Structure of a Recording Sheet

In a preferable structure of a recording sheet according to this invention, a layer comprising a cationic particulate organic component is used in a layer involved in ink reception, and more preferably is in the outermost layer in the recording surface side of the recording sheet.

A conventionally used gloss layer mainly comprising silica or alumina particles may be provided on the layer comprising a cationic particulate organic component in this invention. Such a gloss layer may cause deterioration in light resistance or anti-yellowing property so that the layer comprising a cationic particulate organic component is preferably the top layer.

The amount of a cationic particulate organic component in this invention is generally, but not limited to, 1 to 300 g/m² on a sheet support as a basis weight.

A recording sheet of this invention can be provided by sequentially forming an ink receiving layer with good ink absorbency and a layer comprising a cationic particulate organic component on a support.

Types of a Sheet Support

A support used in this invention can be a support conventionally used for an inkjet recording sheet including papers such as a regular paper, an art paper, a coat paper, a cast coat paper, a resin coated paper, a resin impregnated paper, an uncoated paper and a coated paper; plastics; unwoven fabrics; cloths; woven fabrics; metal films; metal plates; and composite supports wherein these materials are piled.

Examples of a plastic which can be used for a support include plastic sheets and films made of polyethylene, polypropylene, polystyrene, polyethylene terephthalate, polyethylene naphthalate, triacetyl cellulose, polyvinyl chloride, polyvinylidene chloride, polyimides, polycarbonates, cellophane or polynylon. Such a plasticsupport may be transparent, translucent or opaque as appropriate according to its use.

A support is preferably a white plastic film. Examples of a white plastic support include plastics containing a small amount of a white pigment such as barium sulfate, titanium dioxide and zinc oxide; cellular plastics opacified by forming numerous fine forms; and supports comprising a layer containing a white pigment such as titanium dioxide and barium sulfate.

A support used in this invention can have a shape selected from the group consisting of, but not limited to, a film, a sheet, a plate, a cylinder such as a drink can, a disc such as CD and CD-R and other complex shapes.

Preparation of a Recording Sheet

A recording sheet according to this invention can be prepared by applying a coating composition comprising a cationic particulate organic component on one or both sides of a sheet support and then drying the product. A coating liquid can be applied by conventional application means such as, but not limited to, an air knife coater, a roll coater, a bar coater, a blade coater, a slide hopper coater, a gravure coater, a flexo-gravure coater, a curtain coater, an extrusion coater, a floating knife coater, a comma coater and a dye coater.

Gloss can be endowed by a conventional method such as, but not limited to, common calendering where a sheet is passed between hot pressed rolls using a calendering apparatus such as a super calender and a gloss calender to make the coating surface flat.

In this invention can be preferably used cast coating, which is generally used for preparation of a printing cast coat paper, such as direct casting, coagulation casting, rewet casting (re-wetting method) and precasting. Cast coating is a technique where a coated layer on a support is made wet and pressed on a hot mirror roll to transfer the mirror surface of the roll for giving gloss while drying the layer during being in contact with the roll.

Direct casting is a technique where an undried coated layer is dried by being pressed onto a hot mirror roll. Re-wetting casting is a technique where after drying, a coated layer is re-wetted in a liquid mainly containing water and then dried by pressing it onto a hot mirror roll. A recording sheet according to this invention is preferably prepared by direct or re-wet cast coating.

Conditions in cast coating such as a pressure during pressing, a mirror roll temperature and a coating rate can be selected as appropriate. In particular, a mirror roll temperature is lower than a glass transition temperature of a cationic particulate organic component and in general, is preferably lower than the glass transition temperature by 3 to 40° C. If the mirror roll temperature is the glass transition temperature of a cationic particulate organic component or higher, voids tend to be reduced, leading to reduced ink absorbency.

This invention will be illustrated with reference to, but not limited to, examples. In these examples, “parts” and “%” represent “parts by weight” and “% by weight”, respectively, unless specifically stated.

### EXAMPLE 1

In a reaction vessel were placed 195.9 parts of deionized water and 0.1 parts of stearyl-trimethylammonium chloride and the mixture was heated to 70° C. under nitrogen stream. To the mixture was added 0.6 parts of 2,2′-azobis(2-amidinopropane) dihydrochloride. Separately, an emulsion mixture was prepared by adding 0.3 parts of stearyl-trimethylammonium chloride to a mixture of 74.0 parts of methyl methacrylate, 10.0 parts of n-butyl acrylate and 16.0 parts of N,N-dimethylaminopropylacrylamide in 40 parts of deionized water. The emulsion mixture was added dropwise into the above reaction vessel over 4 hours, and the resulting mixture was kept at the same temperature for 4 hours. To the mixture was added 0.1 parts of 2,2′-azobis(2-amidinopropane)-dihydrochloride and the mixture was kept at the same temperature for 3 hours for completion of polymerization.

As a result, an emulsion was prepared, in which the cationic particulate organic component was dispersed in water and contained 30% of nonvolatiles and whose pH was 5. It had an average particle size of 199 nm as determined by light scattering measurement and a glass transition temperature of 85.0° C. as determined from a DSC curve according to JIS K 7121.

Preparation of a Recording Sheet

On a fine paper with a basis weight of 105 g/m² was applied the emulsion composition in which the cationic particulate organic component was dispersed in water to a coating amount of 20 g/m² in an absolute dry state. The layer was dried by cast coating; specifically, it was dried while being pressed onto a mirror roll whose surface temperature was kept at 80° C. under a linear pressure of 100 kg/cm, to give a recording sheet of Example 1.

### EXAMPLE 2

To water were added 100 parts of fine silica and 20 parts of completely saponified polyvinyl alcohol and the resulting mixture was stirred to give a coating composition with a solid content of 15%. The coating composition was applied on a fine paper with a basis weight of 105 g/m² to a coating amount of 20 g/m² in an absolute dry state and the mixture was dried at 120° C. for 1 min. The coated layer to be an ink receiving layer has a coarse surface exhibiting a glossiness of 23 at 75° in this state. On the upper layer was further applied the emulsion composition in which the cationic particulate organic component was dispersed in water as prepared in Example 1, to a coating amount of 6 g/m² in an absolute dry state. The layer was dried by cast coating; specifically, it was dried while being pressed onto a mirror roll whose surface temperature was kept at 80° C. under a linear pressure of 100 kg/cm, to give a recording sheet of Example 2.

### Comparative Example 1

### Preparation of an Anionic Particulate Organic Component

In a reaction vessel were placed 195.9 parts of deionized water and 0.1 parts of sodium dodecylbenzenesulfonate and the mixture was heated to 70° C. under nitrogen stream. To the mixture was added 0.5 parts of potassium persulfate. Separately, an emulsion mixture was prepared by adding 0.3 parts of sodium dodecylbenzenesulfonate to a mixture of 74.0 parts of methyl methacrylate, 10.0 parts of n-butyl acrylate and 16.0 parts of methacrylic acid in 40 parts of deionized water. The emulsion mixture was added dropwise into the above reaction vessel over 4 hours, and the resulting mixture was kept at the same temperature for 4 hours to complete polymerization.

As a result, an emulsion was prepared, in which the anionic particulate organic component was dispersed in water and contained 30% of nonvolatiles and whose pH was 2. It had an average particle size of 120 nm as determined by light scattering measurement and a glass transition temperature of 86.2° C. as determined from a DSC curve according to JIS K 7121.

Preparation of a Recording Sheet

A recording sheet of Comparative Example 1 was prepared as described “Preparation of a recording sheet” in Example 1, substituting the emulsion composition where an anionic particulate organic component was dispersed in water for the emulsion composition where a cationic particulate organic component was dispersed in water

### Comparative Example 2

A recording sheet of Comparative Example 2 was prepared as described in Comparative Example 1, except the surface temperature of the mirror roll was 100° C.

### Comparative Example 3

To water were added 100 parts of fine silica and 20 parts of completely saponified polyvinyl alcohol and the resulting mixture was stirred to give a coating composition with a solid content of 15%. The coating composition was applied on a fine paper with a basis weight of 105 g/m² to a coating amount of 20 g/m² in an absolute dry state and the mixture was dried at 120° C. for 1 min to give a recording sheet of

### Comparative Example 3.

Evaluation

The quality evaluation results for the recording sheets are shown in Table 1. Evaluation was conducted according to the following procedure.

Determination of a Liquid Absorption

A liquid absorption was determined using DAT (Dynamic Absorption Tester) 1100 DAT MKII (FIBRO Company) and a liquid absorption in a unit of volume (μL) and a liquid absorption per unit area (μL/cm²) were estimated. Specifically, on a sample surface was dropped 4 μL of pure water, and the state after dropping was videotaped. Then, from the video image taken were determined a contact angle and a diameter of the droplet 0.1 sec after dropping, from which the remaining liquid amount on the sample surface was estimated. A difference between the remaining amount and the initial droplet amount was calculated as a liquid absorption. The calculated value was divided by a contact area estimated from the diameter of the dropped droplet to calculate a liquid absorption per unit area (μL/cm²). The calculation equation is as follows.

Liquid absorption per unit area (μL/cm²)=Liquid absorption (>L)/[(Diameter of a droplet (cm)/2)²×π]

Determination of Gloss

Gloss was determined as a glossiness on a recording sheet surface at 75° using a bending glossimeter type GM-3D (Murakami Color Technology Institute) according to JIS Z 8741.

Determination of a Color Density

Contact printing with black ink was conducted using a commercially available inkjet printer (Seiko Epson Inc., PM 2000C). An optical reflection density was determined using a Macbeth densitometer (RD-918).

Determination of Ink Absorbency

Vertical contact printing with four kinds of color namely, yellow, magenta, cyan and black inks was conducted using a commercially available inkjet printer (Seiko Epson Inc., PM 2000C). Immediately after being ejected from the printer, the upper part of the paper was pressed onto a PPC paper for visually evaluating a degree of transfer of the inks to the PPC paper according to the following evaluation rates:

∘: no ink transfer, good ink absorbency;

Δ: some ink transfer, practically acceptable ink absorbency;

X: much ink transfer, practically unacceptable absorbency.

Determination of Water Resistance

Text printing was conducted with black ink using a commercially available inkjet printer (Seiko Epson Inc., PM 2000C). The print was evaluated after immersing in a tap water at 30° C. for 2 min. Specifically, its printing state after immersion was visually evaluated for some parameters such as spreading according to the following rates:

∘: substantially no spreading or color density variation,

Δ: some spreading and color density loss, but practically acceptable,

X: significant spreading and color density loss, practically unacceptable.

Determination of Light Resistance

Contact printing was conducted with magenta ink using a commercially available inkjet printer (Seiko Epson Inc., PM 2000C). Using a xenon fade meter, the printed recording sheet was irradiated with light for 100 hours and light resistance was determined as a persistence of an optical reflection density after irradiation to that before irradiation. An optical reflection density was determined using a Macbeth densitometer (RD-918).

Determination of Anti-Yellowing Property

Using a carbon arc fade meter, an unprinted recording sheet was irradiated with light for 7 hours and a color difference between before and after irradiation was determined. A color difference (AE) was calculated from the results of color determination before and after light irradiation using the following equation according to L*a*b* (expression according to CIE). A larger color difference indicates larger color deterioration.

ΔE={(ΔL*)²+(Δa*)²+(Δb*)²}^{1/2}

TABLE 1

| | Liquid | | | | | | | |
|---|---|---|---|---|---|---|---|---|
| | absorption | | | link | Color | Water | Light | Antiyellowing |
| | μL | μL/cm² | Gloss | absorpt. | density | resist. | resist (%) | ΔE |
| Ex. 1 | 3.05 | 1.1 | 71 | ∘ | 2.28 | ∘ | 79.8 | 1.1 |
| Ex. 2 | 3.21 | 1.2 | 72 | ∘ | 2.35 | ∘ | 80.2 | 1.0 |
| Comp. Ex. 1 | 1.10 | 0.08 | 57 | Δ | 1.71 | x | 71.3 | 1.2 |
| Comp. Ex. 2 | 0.03 | 0.05 | 67 | x | 1.89 | Δ | 75.2 | 1.2 |
| Comp. Ex. 3 | 2.77 | 0.69 | 23 | ∘ | 1.73 | x | 80.5 | 2.1 |

As described above, this invention can provide an ink-jet recording sheet with excellent gloss, ink absorbency, color density, water resistance, light resistance and anti-yellowing property, as well as a process for manufacturing the recording sheet.

What is claimed is:

1. An inkjet recording sheet comprising at least one layer containing a cationic particulate organic component on a sheetsupport, wherein the layer containing the cationic particulate organic component comprises a void-forming component consisting substantially of a cationic particulate organic component selected from the group consisting of (meth)acrylate (co)polymers, methyl methacrylate-butadiene copolymers, styrene-butadiene copolymers, ethylene-vinyl acetate copolymers and olefinic polymers, and copolymers of two or more of these, which are endowed with a cationic function.

2. The inkjet recording sheet as claimed in claim 1, wherein the cationic particulate organic component is a thermoplastic particulate resin.

3. The inkjet recording sheet as claimed in claim 1 or 2, wherein the cationic particulate organic component is a cationic particulate emulsion prepared by copolymerizing (A) an alkyl (meth)acrylate, (B) an amino group containing (meth)acrylate monomer and (C) other copolymerizable monomer.

4. The inkjet recording sheet as claimed in claim 3, wherein the amounts of (A) the alkyl (meth)acrylate monomer, (B) the amino group containing (meth)acrylate monomer and (C) the other copolymerizable monomer are 30 wt % to 99.8 wt %, 0.2 wt % to 40 wt % and 0 wt % to 30 wt %, respectively, based on the total weight of (A), (B) and (C).

5. The inkjet recording sheet as claimed in any of claims 1 to 4, wherein the glass transition temperature of the cationic particulate organic component is 65° C. to 200° C. both inclusive.

6. The inkjet recording sheet as claimed in any of claims 1 to 5, wherein the weight average molecular weight of the cationic particulate organic component is 60000 or more.

7. The inkjet recording sheet as claimed in any of claims 1 to 6, wherein the recording sheet has a liquid absorption of 2.00 to 4.00 μL 0.1 sec after dropping 4 μL of pure water on its recording surface and has gloss of 50 or more at 75°.

8. The inkjet recording sheet as claimed in any of claims 1 to 7, wherein the recording sheet has a liquid absorption per contact area of a droplet of 0.5 to 2.00 μL/cm² 0.1 sec after dropping 4 μL of pure water on the recording surface of the recording sheet.

9. The inkjet recording sheet as claimed in any of claims 1 to 8, wherein the layer containing the cationic particulate organic component is the outermost layer of the recording surface.

10. The inkjet recording sheet as claimed in any of claims 1 to 9, wherein the sheet support is a paper or plastic sheet.

11 The inkjet recording sheet as claimed in any of claims 1 to 10, wherein the layer containing the cationic particulate organic component contains no inorganic particles.

12 A process for manufacturing the inkjet recording sheet as claimed in any of claims 1 to 11 wherein a layer containing a cationic particulate component is applied by cast coating, comprising the steps of applying a coating composition containing the cationic particulate organic component on a sheet support and pressing a mirror roll onto the coated surface.

13. The process for manufacturing the inkjet recording sheet as claimed in claim 12, wherein the surface temperature of the mirror roll is lower than a glass transition temperature of the cationic particulate organic component.
